(19) United States
(12) Patent Application Publication
(10) Pub. No.: US 2025/0017349 A1
(43) Pub. Date: Jan. 16, 2025

(54) NAIL DECAL KIT WITH APPLICATOR

(71) Applicant: KMC Exim Corp., Port Washington, NY (US)

(72) Inventor: Sung Yong Chang, Roslyn Heights, NY (US)

(21) Appl. No.: 18/221,974

(22) Filed: Jul. 14, 2023

(51) Int. Cl. A45D 29/00; A45D 29/18; B32B 7/06; B32B 7/12; B32B 27/06

(52) U.S. Cl. CPC A45D 29/001; A45D 29/18; B32B 7/06; B32B 7/12; B32B 27/06; A45D 2200/25; B32B 2307/412; B32B 2307/748; B32B 2405/00; B32B 2451/00

(57) ABSTRACT

A nail decorating kit includes a release substrate, a plurality of nail decals peelably adhered to the release substrate and an applicator peelably adhered to the release substrate for transferring a selected decal from the release substrate to a fingernail or a toenail. A method for applying decals to a fingernail or toenail includes the steps of providing a release substrate having a plurality of nail decals and an applicator peelably adhered thereto, peeling the applicator from the release substrate, pressing an applicator end against a top surface of a selected decal, peeling the selected decal off the release substrate using the applicator, wherein the selected decal is temporarily adhered to the applicator end, pressing the decal against a fingernail or toenail with the applicator end of the applicator and releasing the applicator end from the top surface of the decal, whereby the decal is adhered to the fingernail or toenail.

### BACKGROUND OF THE INVENTION

The present invention relates generally to nail decals or appliqués that are applied to natural nails with an adhesive to enhance the cosmetic appearance of the nail, and more particularly to a set of such nail decals including an applicator and a method for applying such nail decals or appliqués.

Artificial nails, nail decals and nail appliqués have been used for many years to enhance the cosmetic appearance of the fingers and toes. Some individuals opt to use artificial nails because their own nails are too weak to grow to a desirable length without breaking. Others choose artificial nails because they are considerably stronger and more durable than natural nails, and because nail polish adheres better to the artificial nail surface. Some individuals are unhappy with the shape and contour of their natural nail and opt to use an artificial nail to improve the appearance of their nails.

It has been known in the art of adorning the hands to provide ornamental fingernail accessories made from thin, molded plastic members manufactured generally in the shape of a fingernail. Indeed, numerous artificial fingernail manufacturers have provided a variety of combinations of materials, arrangements, and colors in fingernail accessories. For example, many conventional pre-designed fingernails often include a decorative design stenciled or air-brushed on a top surface thereof.

The pre-designed artificial nail is glued to the surface of the natural nail by applying an amount of a liquid bonding adhesive to the bottom surface of the artificial nail and/or the top surface of the natural nail to affix the accessory to the nail. An overlay is then typically applied to the entire top surface of the artificial nail. The overlay is usually transparent or translucent so that the decorative design is visible on the top surface of the artificial nail. Once the overlay sets, the artificial nail is shaped as desired.

It has also been known in the art of adorning fingernails and/or toenails with nail decals or appliqués. Such decals or appliqués typically take the form of a thermal- and/or pressure-sensitive adhesive-backed film, which adds strength and beauty to nails. The application of an opaque or clear graphic film onto fingernails or toenails provides the elements of nail polish, but includes the added benefits of nail support, graphics, specialty colors, no liquid, no dry time, no brush, no mess, no uneven brush strokes, no chipping, no known cancer causing chemicals, no fumes, and easy removal. With the advent of such artificial fingernail accessories, the wearer could now have intricately pre-designed fingernails that are attached to the natural fingernail and then later easily removed.

However, conventional nail decals or appliqués are typically provided as an assortment of decorative designs provided on one or more transfer sheets. Typically, the decorative designs are stenciled, air-brushed or hand-painted on some form of transfer sheet, wherein the user must typically select a design from the sheet and apply it to the natural nail. Often times, the designs are densely grouped on the transfer sheet, which makes application of a single decal from the group a difficult process.

Specifically, in the case of decals using water activated adhesives, water applied to the substrate to loosen the selected decal will often run into neighboring decals on the substrate. Alternatively, extricating the selected design from the others by cutting can also be a difficult process. In particular, once the selected design is cut from the transfer sheet, the user is left with a small piece of paper, or other carrier material, having the decal thereon, which then must be manipulated into position over the natural nail in order to apply the decal to the natural nail. Obviously, such manipulation is difficult and often leads to the decal being dropped or the decal being misapplied to an undesirable location of the nail.

Accordingly, it would be desirable to provide a set of nail decals or appliqués that provides the user with multiple design variations depending on how the appliqué is placed on the natural nail. It would be further desirable to provide a single set of nail decals that eliminates the step of cutting an individual decal out from the others. It would be still further desirable to provide a single set of nail decals with an applicator that can be easily manipulated during application and has provisions to aid in the accurate positioning of the decals on the nails.

### SUMMARY OF THE INVENTION

The present invention is a nail decorating kit including a release substrate, a plurality of nail decals peelably adhered to the release substrate and an applicator peelably adhered to the release substrate for transferring a selected decal from the release substrate to a fingernail or a toenail.

In an embodiment, the applicator has a transparent applicator end. This can be achieved by forming the applicator with a transparent base layer having a handle portion and an applicator end portion, a non-transparent design layer disposed on the handle portion of the transparent base later and an adhesive layer disposed on the applicator end portion of the transparent base layer, wherein the applicator end portion forms the transparent applicator end.

Each decal preferably has an adhesive layer disposed on a bottom surface thereof and the applicator has an adhesive layer disposed on a bottom surface thereof. The adhesive layer of each decal has an adhesive strength with respect to the release substrate less than an adhesive strength of the applicator adhesive layer with respect to a top surface of each decal.

Preferably, the adhesive layer of the applicator has a tackiness between the adhesive layer and the fingernail larger than a tackiness between the adhesive layer and a top surface of the selected decal. More particularly, the adhesive layer of each decal has a tackiness of 300-25,000 gf/in and the adhesive layer of the applicator has a tackiness of 5-15,000 gf/in.

In an embodiment, the plurality of nail decals are peelably adhered to a decal portion of the release substrate and the applicator is peelably adhered to an applicator portion of the release substrate. The decal portion is separated from the applicator portion by a perforation so that the applicator portion can be easily separated from the decal portion.

The present invention further involves a method for applying decals to a fingernail or toenail. The method includes the steps of providing a release substrate having a plurality of nail decals and an applicator peelably adhered thereto, peeling the applicator from the release substrate, pressing an applicator end against a top surface of a selected decal, peeling the selected decal off the release substrate using the applicator, wherein the selected decal is temporarily adhered to the applicator end, pressing the decal against a fingernail or toenail with the applicator end of the applicator, and releasing the applicator end from the top surface of the decal, whereby the decal is adhered to the fingernail or toenail.

In the method for applying decals to fingernails or toenails according to the present invention, a substrate with a plurality of decals and an applicator temporarily affixed to a surface thereof, as described above, is utilized. The method includes the steps of removing the applicator from the substrate, applying an adhesive side of the applicator to a top surface of a selected decal, removing the decal from the substrate with the decal adhered to the adhesive side of the applicator, manipulating the applicator to apply the decal to a top surface of a nail and transferring the decal to the nail by detaching the decal from the applicator. In an embodiment, the transferring step includes the step of applying pressure to the decal with the applicator so that the decal will adhere to the nail.

The preferred embodiments, as well as other objects, features and advantages of the present invention will become apparent from the following detailed description considered in conjunction with the accompanying drawings. It is to be understood, however, that the drawings are intended as an illustration only and not as a definition of the limits of the invention. The scope will be pointed out in the claims.

### BRIEF DESCRIPTION OF THE DRAWINGS

FIG. 1 shows a set of nail decals with a applicator formed in accordance with the present invention.

FIG. 2 is a cross-sectional view of one of the decals shown in FIG. 1 taken along line 2-2.

FIG. 3 is a cross-sectional view of one of the applicators shown in FIG. 1 taken along line 3-3.

FIG. 4 shows use of the applicator in a first step of a method for applying nail decals according to the present invention.

FIG. 5 shows use of the applicator in a second step of the method for applying nail decals according to the present invention.

FIG. 6 shows use of the applicator in a third step of the method for applying nail decals according to the present invention.

FIG. 7 shows use of the applicator in a fourth step of the method for applying nail decals according to the present invention.

### DETAILED DESCRIPTION OF THE PREFERRED EMBODIMENTS

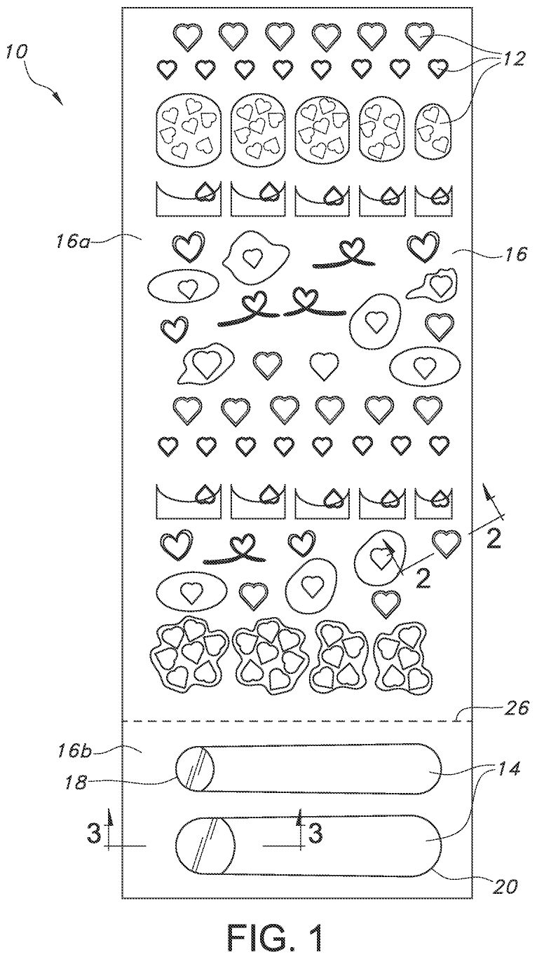

FIG. 1 shows a preferred embodiment of a nail decal application kit 10 formed in accordance with the present invention for decorating fingernails or toenails. The kit 10 includes a plurality of spaced decals 12 and at least one applicator 14 temporarily affixed to a unitary substrate 16. The decals 12 can have a variety of designs and/or colors and can be differently sized to fit different sizes of nails. The one or more applicators 14 can also be provided in different sizes to allow for convenient use with different sizes of nails.

Preferably, the decals 12 are arranged on the substrate 16 in an aesthetically pleasing, as well as a functional pattern. For example, the decals 12 can be arranged in order of size and positioned side-by-side in rows of similar designs. Since all the decals 12 and the applicator 14 are provided on a single substrate 16, the decal application kit 10 is rendered relatively easy to manufacture and to handle for subsequent packaging and use.

The decals 12 can be provided on a portion 16a of the substrate 16 separate from a portion 16b on which the applicator 14 is provided. A perforation 26 can be formed in the substrate 16 to allow convenient separation of the applicator portion 16b from the decal portion 16a.

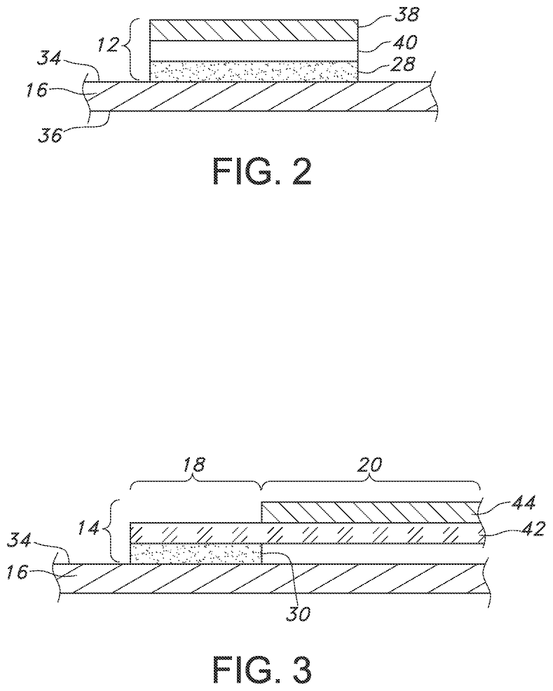

Referring additionally to FIGS. 2 and 3, each decal 12 is temporarily affixed to a top surface 34 of the substrate 16. The decal 12 itself may include a design layer 38, a base layer 40 provided on the lower surface of the design layer and an adhesive layer 28 provided on the lower surface of the base layer and peelably adhered to the top surface 34 of the substrate 16. In this regard, the adhesive layer 28 is provided on a bottom surface of each decal 12 in a typical laminar structure as is well known in the art. In a preferred embodiment, the adhesive 28 is a pressure-sensitive, self-adhesive 28, which is releasably peelable from the substrate 16.

FIG. 2 shows the decal with the design layer 38 and the base layer 40 stacked on the upper surface of the adhesive layer 28 in a sequential order. However, the base layer 40 according to this embodiment may be provided on the upper layer of the design layer 38.

The substrate 16 takes the form of a release sheet for the decals 12. The substrate 16 may be manufactured by surface coating with silicone, Teflon and fluorine on a film or a sheet made of one selected from paper, poly vinyl chloride (PVC), polyethylene (PE), polyurethane (PU), polypropylene (PP), polyethylene phthalate (PET), polyolefin elastomer (POE), ethylene-vinyl acetate copolymer (EVA) and acrylic resin or polymers thereof.

In this embodiment, the surface tension of the release substrate 16 is 36 dyne/cm or less per unit width, to easily peel the adhesive layer 28 off from the substrate and prevent tearing and pop-up. Additionally, the tackiness of the adhesive layer 28 is preferably 300-25,000 gf/in. The tackiness measurement may be performed in accordance with ASTM D3330 180 degree PEEL TEST.

For example, when attaching the decal 12 to the nail bed of a natural nail 32, in case that the tackiness of the adhesive layer 28 is less than 300 gf/in, the adhesive layer is spaced apart from the nail bed and it is more likely to be separated from the nail bed, and in case that the tackiness of the adhesive layer exceeds 25,000 gf/in, the nail bed may be damaged when the user separates the adhesive layer from the nail bed for replacement purposes.

The base layer 40 may be a film or a sheet made of one selected from poly vinyl chloride (PVC), polyethylene (PE), polyurethane (PU), polypropylene (PP), polyethylene phthalate (PET), polyolefin elastomer (POE), ethylene-vinyl acetate copolymer (EVA) and acrylic resin or polymers thereof.

Additionally, although not shown, a color ink may be printed on the upper surface or the lower surface of the base layer 40 by one selected from screen, offset and gravure printing methods. In this instance, the entire upper or lower surface of the base layer 40 may be printed in one color, but is not limited thereto, and the entire upper or lower surface of the base layer 40 may be divided into a plurality of areas and each area may be printed in different colors or predetermined colors repeatedly. The colors printed on the base layer 40 may achieve more unique color reproduction by projection on a transparent hologram film in case that the design layer 38 is formed from a transparent hologram film.

Additionally, although not shown, a metal thin film of aluminum (Al), nickel (Ni) and chrome (Cr) may be deposited on the upper surface and the lower surface of the base layer 40. The metal thin film may be manufactured transparently or opaquely according to the stack thickness. The metal thin film deposited on the base layer 40 can provide a variety of metallic sensations and hologram effects.

The design layer 38 may be a transparent or opaque film or sheet stacked on the upper surface of the base layer 40 or between the base layer and the adhesive layer 28. The design layer 38 may include a transparent hologram film having various hologram patterns and designs formed on one surface of a base film. The hologram film varies colors or designs depending on viewing directions.

In an alternative embodiment, the decal adhesive 28 is a water activated or water soluble adhesive and the substrate 16 is made of a water permeable material so as to allow water, applied to a bottom surface 36 of the substrate, to pass through the substrate to activate the adhesive disposed on the bottom surface of the decal 12. The moistened decal 12, with adhesive 28, is thus released from the substrate 16 and can be transferred to a human fingernail or toenail. Such water activated adhesives are well known in the art of nail decal application and will not be described in detail here. Materials used for water permeable carrier substrates, such as paper stock films, for such water activated decal applications are also well known in the art.

In another alternative embodiment, a dry transfer decal adhesive can be utilized, wherein the decal 12 is transferred to a natural fingernail or toenail using a dry transfer technique known in the art.

The kit 10 of the present invention further includes an applicator 14 to integrally peel the decal 12, including the design layer 38, the base layer 40 and the adhesive layer 28, and attach the peeled design layer, base layer and adhesive layer to a nail bed of a natural nail 32. Referring additionally to FIG. 3, in a preferred embodiment, the applicator 14 is an elongate strip member having a longitudinal extent with an applicator end 18 and a handle portion 20 extending from the applicator end. It is however conceivable for the applicator 14 to have different shapes.

In any case, the applicator 14 preferably includes a base layer 42, a design layer 44 and an adhesive layer 30. In the embodiment shown in FIG. 3, the base layer 42 is made from a transparent film. The design layer 44 is colored or opaque or otherwise non-transparent and is provided on a top surface of the base layer 40 and defines the extent of the handle portion 20. The adhesive 30 is provided on a bottom surface of the base layer 40 and defines the extent of the applicator end 18 of the applicator. As such, the adhesive 30 does not overlap the design layer in the longitudinal direction of the base layer 42. This will allow for more convenient handling of the handle portion 20, as will be discussed below. Additionally, the applicator end 18, defined by the adhesive layer is not obscured by the design layer 44 and is, thus, transparent, for reasons that will also be discussed further below.

The applicator 14 is also temporarily affixed to the top surface 34 of the substrate 16 via a releasable adhesive layer 30. However, in this case, the applicator adhesive 30 is more preferably limited to a pressure-sensitive, self-adhesive 30 so as to be releasably peelable from the substrate 16.

The applicator 14 may be formed in the shape of a long rod to allow the user to hold, but the scope of protection of the present disclosure is not limited thereto, and any shape the user can hold is available. Additionally, the applicator end 18 shown in the drawings extends from one end of the handle portion 20, but it is conceivable that two applicator ends can be provided on opposite ends of the handle portion. When the applicator end is formed at two ends of the handle portion 20, sizes may be different to match the size of the decal 12 or the natural nail 32. In the alternative, or in addition, multiple sizes of applicators 14 can be provided on the substrate 16.

The adhesive layer 30 provided at the applicator end 18 of the applicator 14 plays a role in adhering the decal 12 and integrally peeling the decal 12 off from the release substrate 16. Additionally, the decal 12 adhered to the adhesive applicator end 18 is transferred to the upper surface of the nail bed of the natural nail 32.

Specifically, as will be discussed further below, the adhesive layer 30 of the applicator end 18 comes into contact with the upper surface of the decal 12 adhered to the release substrate 16, the applicator end 18 is pressed with a finger to integrally adhere the decal to the applicator 14, and the decal is peeled off from the release substrate 16. Subsequently, the decal adhered to the applicator end 18 comes into contact with the upper surface of the nail bed of the natural nail 32, and the applicator end 18 is pressed with a finger to attach the decal 12 onto the nail bed of the natural nail 32.

To attach the decal 12 to the nail bed of the natural nail 32, the tackiness between the decal adhesive layer 28 provided below the design layer 38 of the decal 12 and the nail bed of the natural nail needs to be larger than the tackiness between the decal 12 and the adhesive layer 30 of the applicator 14. Specifically, the tackiness of the adhesive layer 30 of the applicator 14 is preferably 5-15,000 gf/in.

For example, when attaching the decal 12 to the natural nail 32, in case that the tackiness of the applicator adhesive 30 is less than 5 gf/in, it may not be easy to integrally peel the decal 12 off from the release substrate 16, and in case that the tackiness of the applicator adhesive 30 exceeds 15,000 gf/in, the percentage of transfer for attaching the decal 12 to the natural nail may be reduced. Accordingly, the tackiness of the adhesive layer 30 provided at the applicator end 18 of the applicator 14 is preferably 5-15,000 gf/in.

As used herein, exemplary nail decals 12 and applicators 14 may include, for example, any non-liquid thermally curable pressure sensitive self-adhesive film. Exemplary materials may include thermal sensitive graphic films. Graphic film suitable for methods embodiments of the present invention may include, for example, any self-adhesive thin film type material vinyl film, cast film (film manufactured by cast method), “2 mil” film, “high performance” film, “long-term” film, or “premium” films. As used herein, “thin film” may include vinyl casting graphic film about 2 millimeters or less. In certain embodiments, the graphic laminate includes a graphic film of about 2 millimeter or less laminated to a clear coat vinyl casting film layer of about 2 millimeter or less. In certain embodiments, film and/or substrates may include various embedded visual effects such as, for example, varying degrees of shading and/or transparencies, varying background patterns, varying optical properties such as, for example, refractivity, fluorescence, pearlescence, night-glow, clear, matte, glossy, holographic, iridescent, glitter, and/or other decorative visual effects.

The decal 12 and the applicator 14 may take the form of a vinyl film. As used herein, the term “vinyl film” may include any solid or flexible film manufactured by casting methods known in the art. Exemplary vinyl casting films are well known in the graphic arts. In certain embodiments, exemplary vinyl films may comprise polyvinylchloride (PVC) polymer, polymeric or monomeric plasticizer (to modulate flexibility), pigment (to make desired coloration), UV absorbers (to improve resistance to UV radiation), heat stabilizers, fillers and processing aids. In certain embodiments, cast films may offer the added benefit of dimensional stability, thinness (about 2 millimeters or less), conformability, durability, and a “paint-like” finish.

The substrate 16 can be formed of any of the materials described above with respect to the decals 12 and the applicator 14. The substrate 16 can also be formed from a paper material. In one exemplary embodiment, the substrate 16, such as paper for example, is coated with an adhesive coating to form a releasable decal adhesive layer 28. A uniform layer of partially cured nail polish material may be applied over the adhesive layer in any desired shape to form the decal 12. Thus, when the film 12 of nail polish is removed from the backing 16, it has an adhesive surface. A nail decal or appliqué 12 formed in this manner can be adhesively secured to a fingernail by placing it and pressing on the nail.

The decals 12 can also take the form of printed films formed by any conventional method. For example, printing methods contemplated as best achieving the desired designs include, but are not limited to, silk screening, flexographic printing, gravure printing, digital printing or Digital Flexo, offset printing, and hot stamping. Alternatively, decorative designs may be made as separate pieces and brought together on a single substrate 16.

Printed graphics layers may consist essentially of a dye- and/or pigment-containing layer capable of adhering, under the action of heat and/or pressure, to a thin film substrate, such as, for example, a vinyl casting film substrate. In this case, the graphics layer is the primary layer which imparts visibility to the graphics laminate. It includes generally a pigment and/or dye material in which the graphic design is formed during the printing process, such as, for example, thermo transfer onto vinyl films. In certain embodiments, the dye or pigment-containing layer may be made up of a plurality of successive dye- or pigment-containing layers.

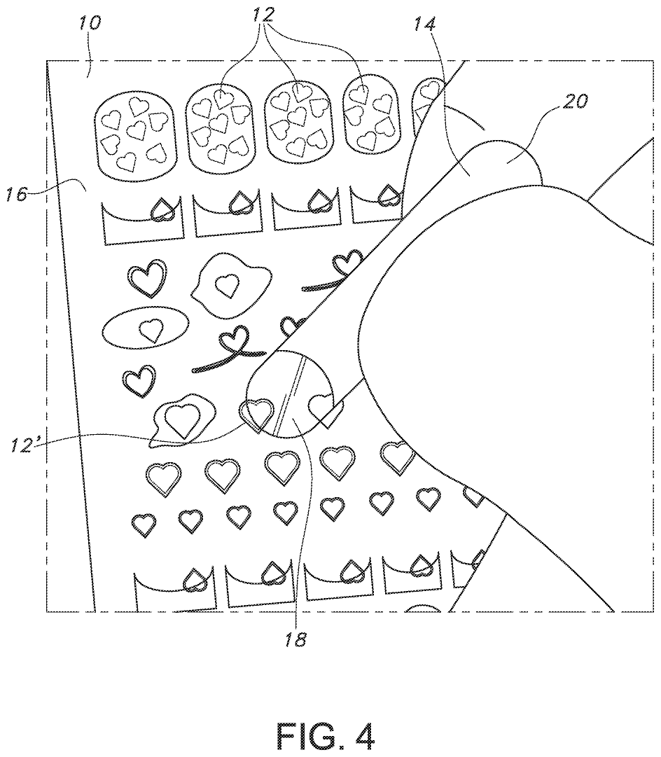

Turning now to FIGS. 4-7, application of the decals 12 to a nail 32 according to the present invention will now be described. In an exemplary manner, to apply a decal 12 of the present invention, the surface of the natural nail 32 to which the decal 12 is to be applied is pre-cleaned (e.g. alcohol or following a manicure).

An applicator 14 is then removed from the substrate 16. The applicator end 18 of the applicator 14 is pressed against the top surface of a desired decal 12′ so as to adhere the decal to the adhesive 30 on the bottom surface of the applicator end, as shown in FIG. 4. The transparency of the applicator end 18 provides convenient viewing of the selected decal 12′.

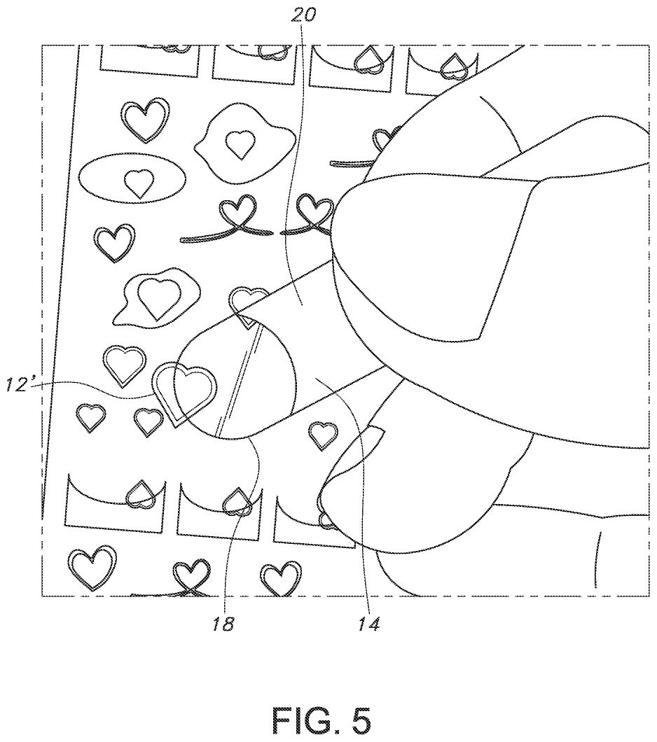

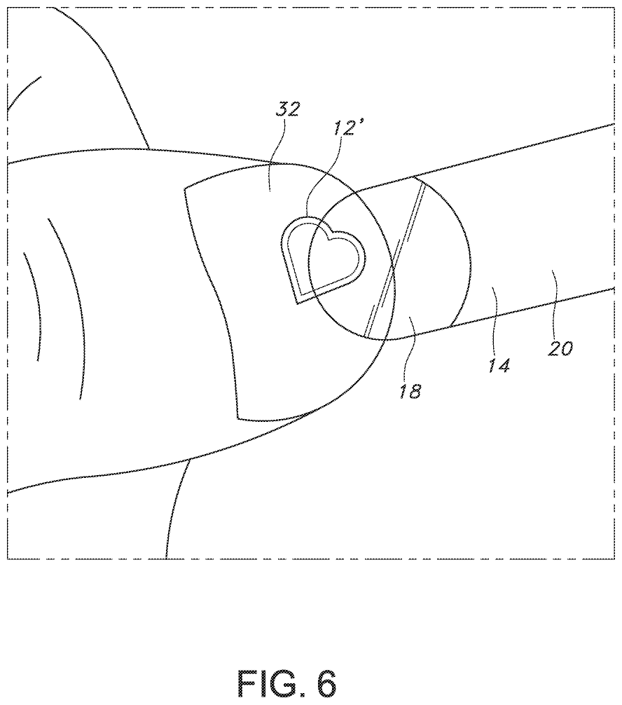

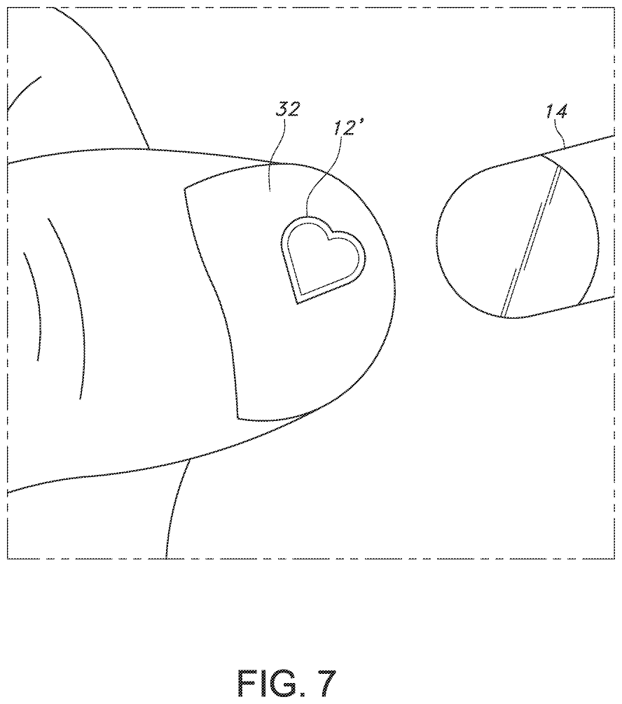

Because the applicator adhesive 30 is stronger than the decal adhesive 28, pulling the applicator 14 away from the substrate 16 will remove the selected decal 12′ from the substrate, as shown in FIG. 5. The applicator end 18, with the attached decal 12′, can then be positioned over a natural nail 32 and, with slight pressure, the decal 12′ can be applied to the natural nail, as shown in FIG. 6. In this case, the adhesive strength between the natural nail bed and the decal 12′ is greater than the adhesive strength between the decal and the applicator 14, so that lifting the applicator away from the natural nail will release the decal from the applicator to remain on the natural nail, as shown in FIG. 7.

As can be appreciated, the elongate handle portion 20 of the applicator 14 provides a convenient means for grasping the applicator with the opposite hand while applying the decal. Also, the transparent applicator end 18 provides a convenient and accurate means for selecting and positioning the decal 12 on the top surface of the natural nail 32.

As mentioned above, the decal 12 can be transferred in several known manners. In a preferred embodiment, the decal 12 is provided with a pressure-sensitive adhesive 28, wherein only a slight amount of pressure is required to remove the decal from the substrate 16 and to apply the decal to the natural nail.

In one of the alternative embodiments, wherein the decal adhesive 28 is a water soluble adhesive and the substrate 16 is water permeable, an amount of water is applied to moisten the bottom surface of the substrate 16 directly below the decal 12 to be applied, while the applicator 14 is pressed against the decal. In other embodiments, a burnishing stick or other utensil is pressed and rubbed on the top surface of the applicator end 18 of the applicator directly opposite the decal to affect a dry-adhesive transfer technique. In certain embodiments, the decal 12 may be pre-heated to facilitate the ease of manipulation. In all cases, however, the adhesive strength between the applicator 14 and the decal 12 is greater than the adhesive strength between the decal and the substrate 16, but less that the adhesive strength between the decal and the natural nail bed.

The decal transfer method using the applicator 14 provided in the kit 10 of the present invention can easily attach the decal 12 to the natural nail 32 having a 3D curve only by the operation of adhering the decal to the applicator, integrally peeling the decal 12 off from the release substrate 16, transferring the decal 12 adhered to the applicator end 18 to the natural nail 32, and pressing the applicator end onto the upper surface of the nail upon contact. Additionally, it is possible to easily attach the decal 12 onto the nail using the applicator 14, thereby reducing the operation time and improving the operation efficiency.

As a result of the present invention, an applicator for accurately and conveniently applying nail decals is provided. The applicator is conveniently provided along with a set of nail decals in a single package.

Although preferred embodiments of the present device and method have been described herein with reference to the accompanying drawings, it is to be understood that the herein device and method are not limited to those precise embodiments and that various other changes and modifications may be affected herein by one skilled in the art without departing from the scope or spirit of the invention, and that it is intended to claim all such changes and modifications that fall within the scope of the invention.

What is claimed is:

1. A nail decorating kit comprising:
a release substrate;
a plurality of nail decals peelably adhered to the release substrate; and
an applicator peelably adhered to the release substrate for transferring a selected decal from the release substrate to a fingernail or a toenail.

2. The nail decorating kit as defined in claim 1, wherein the applicator has a transparent applicator end.

3. The nail decorating kit as defined in claim 2, wherein the applicator comprises:
a transparent base layer having a handle portion and an applicator end portion;
a non-transparent design layer disposed on the handle portion of the transparent base later; and
an adhesive layer disposed on the applicator end portion of the transparent base layer, wherein the applicator end portion forms the transparent applicator end.

4. The nail decorating kit as defined in claim 1, wherein each decal comprises an adhesive layer disposed on a bottom surface thereof and the applicator has an adhesive layer disposed on a bottom surface thereof, the adhesive layer of each decal having an adhesive strength with respect to the release substrate less than an adhesive strength of the applicator adhesive layer with respect to a top surface of each decal.

5. The nail decorating kit as defined in claim 4, wherein the adhesive layer of the applicator has a tackiness between the adhesive layer and the fingernail larger than a tackiness between the adhesive layer and a top surface of the selected decal.

6. The nail decorating kit as defined in claim 5, wherein the adhesive layer of each decal has a tackiness of 300-25,000 gf/in and the adhesive layer of the applicator has a tackiness of 5-15,000 gf/in.

7. The nail decorating kit as defined in claim 1, wherein the plurality of nail decals are peelably adhered to a decal portion of the release substrate and the applicator is peelably adhered to an applicator portion of the release substrate, the decal portion being separated from the applicator portion by a perforation.

8. A method for applying decals to a fingernail or toenail, the method comprising:
providing a release substrate having a plurality of nail decals and an applicator peelably adhered thereto;
peeling the applicator from the release substrate;
pressing an applicator end against a top surface of a selected decal;
peeling the selected decal off the release substrate using the applicator, wherein the selected decal is temporarily adhered to the applicator end;
pressing the decal against a fingernail or toenail with the applicator end of the applicator; and
releasing the applicator end from the top surface of the decal, whereby the decal is adhered to the fingernail or toenail.

9. The method as defined in claim 8, wherein the applicator has a transparent applicator end.

10. The method as defined in claim 9, wherein the applicator comprises:
a transparent base layer having a handle portion and an applicator end portion;
a non-transparent design layer disposed on the handle portion of the transparent base later; and
an adhesive layer disposed on the applicator end portion of the transparent base layer, wherein the applicator end portion forms the transparent applicator end.

11. The method as defined in claim 8, wherein each decal comprises an adhesive layer disposed on a bottom surface thereof and the applicator has an adhesive layer disposed on a bottom surface thereof, the adhesive layer of each decal having an adhesive strength with respect to the release substrate less than an adhesive strength of the applicator adhesive layer with respect to a top surface of each decal.

12. The method as defined in claim 11, wherein the adhesive layer of the applicator has a tackiness between the adhesive layer and the fingernail larger than a tackiness between the adhesive layer and a top surface of the selected decal.

13. The method as defined in claim 12, wherein the adhesive layer of each decal has a tackiness of 300-25,000 gf/in and the adhesive layer of the applicator has a tackiness of 5-15,000 gf/in.

14. An applicator for applying decals to a fingernail or a toenail, the applicator comprising:
a transparent base layer having a handle portion and an applicator end portion;
a non-transparent design layer disposed on the handle portion of the transparent base later; and
an adhesive layer disposed on the applicator end portion of the transparent base layer, wherein the applicator end portion forms a transparent applicator end.
